(19) United States
(12) Patent Application Publication
(10) Pub. No.: US 2015/0142616 A1
(43) Pub. Date: May 21, 2015

(54) Managing a Hierarchy of Online Stores

(71) Applicant: FULLSCALE, INC., BROSSARD (CA)

(72) Inventors: Michael Sheasby, Boucherville (CA); Grayden Wagner, Montreal (CA)

(21) Appl. No.: 14/085,742

(22) Filed: Nov. 20, 2013

(51) Int. Cl. G06Q 30/06; G06F 3/0484; G06F 3/0482; H04L 29/08

(52) U.S. Cl. CPC G06Q 30/0601; G06Q 30/0641; H04L 67/26; G06F 3/04842; G06F 3/0482
USPC 705/27.1; 705/26.1

(57) ABSTRACT

A computer system for supporting multiple hierarchically defined online stores includes a capability for an administrator of an online store to push information from a parent store to one or more child stores, and to pull information from a parent store to a child store. The administrator instructs the computer system what information is to be propagated, and to what extent that information is propagated. The computer system manages conflicts that can arise from the propagation of information from the parent store to the child store.

### BACKGROUND

Merchants commonly use networked computer systems to provide information to consumers, businesses and other customers about products and services, or other items that are available. Generally, a server computer is connected to a publicly accessible computer network, such as the internet, and is accessed by client computers of the customers. In particular, a client computer sends messages to the server computer requesting content that describes the items. The server computer sends response message including the requested content. The client computer then presents the content to the customer enabling the customer to browse for and purchase various items from the merchant. Such a computer system is commonly referred to as an online store.

Such online stores often are not maintained by the merchant, but by a service provider engaged by the merchant to design, build, install, and maintain the online store on server computers maintained by or for the service provider in reliable data centers. Some service providers also manage the financial transactions for the merchant, such that the merchant merely needs to accept and fulfill orders.

An online store typically has an online storefront, which is combination of interrelated electronic documents that are generated by the server computer and sent to a client computer for display on the client computer. These documents, when displayed, generally provide a graphical user interface through which a user can navigate a catalog of items from the online store, specify preferences for options or variations for an item, place items in a “cart” for purchase, and the complete a transaction, all through interaction with the client computer and interaction between the client computer and server computer.

The catalog comprises data stored in a database or file which defines a set of categories, typically arranged in a tree structure, in which specific items are arranged. An item can belong to one or more categories. The cart is a list of items that the customer has selected for purchase. The checkout process involves gathering the customer's preferred payment method and sufficient information for the storefront to process a financial transaction involving the selected items with the customer.

Information about items is typically stored in a database or data file or other form of computer storage. Each item has information associated with it, such as an identifier, pricing information and the like. An item can have a variety of options and variations, which are presented to a customer through a graphical user interface for selection when purchasing the item. Options themselves may have identifiers and display names. Options are typically mutually independent (an option allowing the customer to choose between black and white shirts typically does not affect the price) while variations are typically mutually dependent (a leather-bound, 40-side book may cost more than a leather-bound, 60-side book but less than a paper-bound, 100-side book).

A service provider may provide an online “mall” or set of interrelated online stores. In some instances the service provider merely supports numerous merchants in providing online stores. In such circumstances, it is desirable to provide a way to simplify the creation and maintenance of new online stores by allowing online stores to share infrastructure and content. Generally, service providers use a computer system that maintains data describing online stores in a hierarchy, such that a “child” store obtains various content, products, currency preferences, shipping zones, taxation information, and the like from a “parent” store from which it is derived. In naive implementations, a child store is merely copied from a parent store. After the copy is made however, the child store is independent from the parent store—and thus adding a new item to, or modifying an existing item in, large numbers of stores becomes unwieldy.

### SUMMARY

This Summary introduces selected concepts in simplified form that are further described below in the Detailed Description. This Summary is intended neither to identify key or essential features of the claimed subject matter, nor to limit the scope of the claimed subject matter.

A system for supporting multiple hierarchically defined online stores includes a capability for an administrator of an online store to push information from a parent store to one or more child stores, and to pull information from a parent store to a child store. A person instructs the computer system what information is to be propagated, and to what extent that information is propagated. The system thus allows an administrator to control what information is propagated and when that information is propagated in a manner that is not automatic, but by intent.

Pulling enables the administrator of a child store to determine whether to accept updates to information found in a parent store. Pushing enables the administrator of a parent store to efficiently update a potentially large set of children stores in a uniform manner. The manual nature of the update ensures that unique modifications to the child store's version of the information are not lost during the update. This ability to bulk edit trees of stores is of particular value when dealing with large numbers of similar stores, such as per-school fundraising pages, or technically unsophisticated store owners, such as franchise owners presenting their own versions of products offered by the franchisor, or legally constrained malls, such as where sales collateral includes approved text, or strongly-branded malls where corporate branding is enforced on all child stores.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an illustrative embodiment of an online store system.

FIG. 2 illustrates an example set of data structures for a set of online stores.

FIG. 3 is a flow chart describing pushing elements to a child store.

FIG. 4 is a flow chart describing pulling elements from a parent store.

FIG. 5 is a block diagram of an example computer system.

### DETAILED DESCRIPTION

The following section provides an example operating environment in which hierarchical online stores can be implemented.

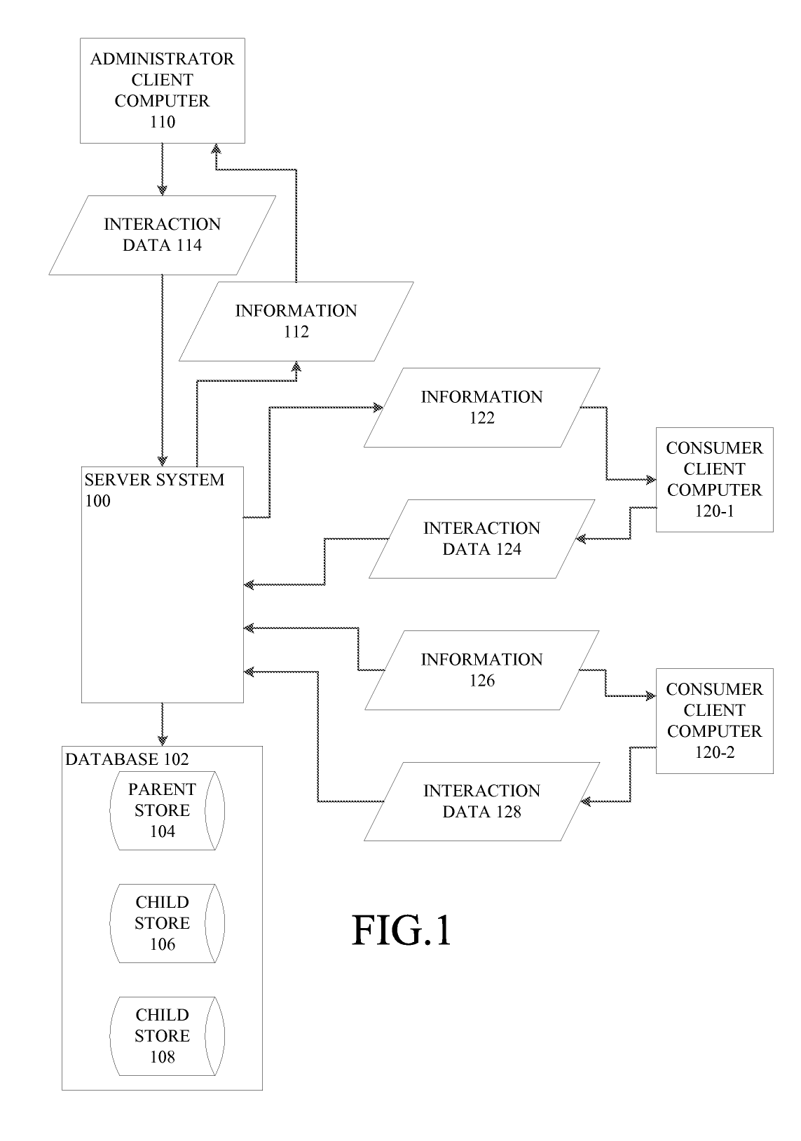

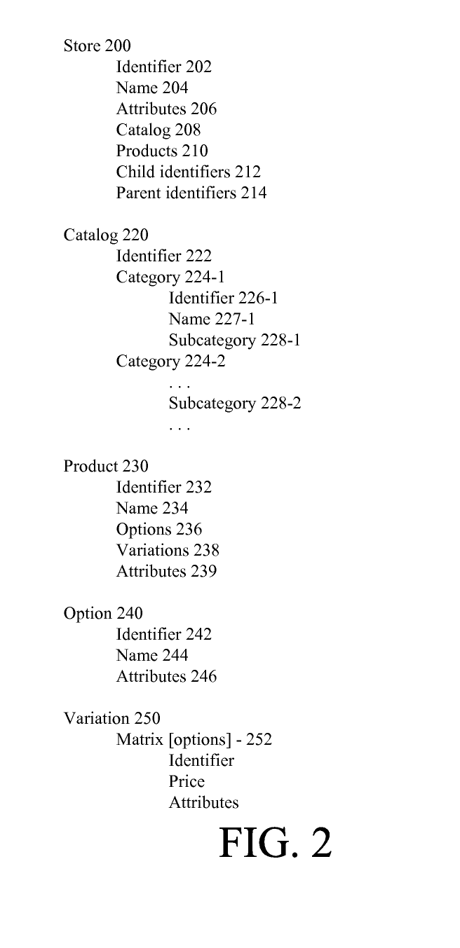

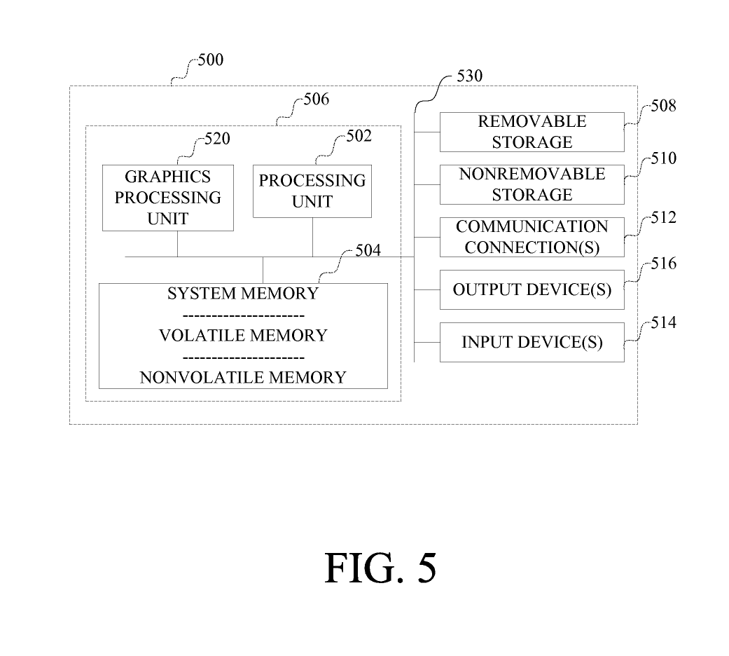

In FIG. 1, a server system 100 includes one or more server computers, of the sort implemented in the manner described below in connection with FIG. 5. A server computer in the server system 100 has access to data, typically in a database 102, that defines one or more online stores. In this illustrative example, the database 102 includes data 104 defining a parent store, data 106 defining a first child store and data 108 defining a second child store. Example implementations of such data defining a store will be described in more detail below in connection with FIG. 2.

One or more administrator client computers 110 access the server system 100 to allow one or more individuals, such as an administrator for a parent store or a child store, to manage, such as create, modify and delete, information about, the stores. Such access typically occurs over a computer network, such as the internet or private computer network, using a communication protocol such as the hypertext transfer protocol (HTTP). The administrator client computers are implemented using a computer system such as described below in connection with FIG. 5. Information 112 about stores, and data for a graphical user interface to manipulate such information, is provided from the server system 100 to the administrator client computer 110 which typically runs what is called a browser application. Interaction data 114, such as information for a store and instructions regarding how to manipulate store data, is provided from the administrator client computer 110 to the server system 100, in response to which the server system 100 updates the data in the database 102.

In a practical implementation, there may be several stores managed by one administrator. For example, a school photographer may service multiple schools, offering each school its own store through which items may be purchased that are unique to that school, but which are variations on kinds of items made available to all of the schools by the photographer. As another example, a franchisee may select items for its store from a variety of items available from a franchisor. The per-store administrator credentials are used to enable administrators to manage items available in the parent and child stores.

Of particular interest herein are products based on photographic images, such as yearbooks, scrapbooks, and other items with photographic images printed on or otherwise applied to the product, and products that are related to affinity groups such as schools, sports teams and other organizations, which may have graphics related to the group, such as a logo, applied to the product. A store may be created uniquely for each affinity group. Such products can include both graphics related to the group and photographic images, such as images taken from an event associated with the group. Thus, a template product (e.g., a sports team calendar) made available by an administrator of a parent store can be customized (e.g., by using a team logo) for each store by the administrator of the child store and then further personalized by each customer (e.g., a customer adds one or more photos that they took at a game).

One or more customer client computers 120 access the server system 100 to allow one or more customers to browse for and purchase items available through the online stores. Such access typically occurs over a computer network, such as the internet or private computer network, using a communication protocol such as the hypertext transfer protocol (HTTP). The customer client computers are implemented using a computer system such as described below in connection with FIG. 5. Information about stores, and data for a graphical user interface to manipulate such information, is provided from the server system 100 to the customer client computer 120. Interaction data, such as requests for information about items and requests to purchase items, is provided from the customer client computer 120 to the server system 100, in response to which the server system 100 provides the requested information and manages information for purchase transactions. In this illustrative example, a first customer client computer 120-1 accesses a first store, receiving information 122 and providing interaction data 124.

A second customer client computer 120-2 accesses a second store, receiving information 126 and providing interaction data 128.

Having described an example operating environment for online stores, an illustrative example of the kind of data stored in a database to define a store will now be described in connection with FIG. 2.

A store is an object and can have an identifier 202 and a display name 204. The identifier of an object is used within the computer system to uniquely identify the object, whereas the display name for an object is used as an identifier that is displayed to a user. A store can have any number of attributes 206, such as a set of available languages and currencies and shipping options, branding, a unique resource locator (URL) for the primary storefront, and the like. A reference to data defining a catalog 208 is stored. Similarly, a reference to its collection of items, in this example, products 210, also is stored. Finally, data for a store can include how it is related to other stores in a hierarchy, by tracking identifiers for its child stores and/or its parent stores, as indicated at 212 and 214.

Notably, a catalog and a list of items can be separate objects. The catalog can be a tree of categories; each item in a collection of items can be associated with one or more categories in the catalog. For example, a catalog 220 can have an identifier 222 and a collection of categories 224. Each category can have an identifier 226 and display name 227, and a collection of one or more subcategories 228. An object representing a category can include the identifier of its parent category.

A product 230 similarly has an identifier 232 and display name 234. Similar information can be provided for other non-product items. A product also can have one or more options 236. An option is a characteristic of the product that can be selected by a customer that may be independently selected and whose effect on the price, if any, is independent from other options. A product also can have one or more variations 238. A variation is a set of N mutually-dependent variants, each determining a specific combination of dependent characteristics of the product. The selection of a variant by a customer may change the price. A given variant may not be offered (for example, a paper-bound album may not offer embossing but a leather album may). By representing variations as an N-dimensional grid of combinations, each cell can indicate whether that combination is available, and each cell can have its own availability, price, SKU, quantity in inventory, thumbnail, per-page pricing, and the like. Finally, various attributes 239 of a product can be stored, such as its price, category, available inventory, dimensions, weight, and other information typically kept for products. An attribute can be a custom attribute defined using data provided by each customer, or each store, or each category, or other sources.

In some systems the options for a product can be attributes of a product, and can, for example, result in different stock keeping units (“SKUs”) being created for each available option for a product. In some systems, an option can be an independent object that is associated with a product, such that there is a SKU created for each product-option pair. Having independent options allows options to be shared among different products. An option 240 typically has an identifier 242, display name 244 and attributes 246.

In one implementation, a variation 238 is a reference to an object 250 representing variations using an n-dimensional matrix 252 of characteristics, in which each cell representing a combination of characteristics. For each cell, there can be an identifier 254, price 256 and various attributes 258. Variations can be specific to a product, or can be independent and then shared among products, such that a product-variation pair specifies a unique product.

An item can have any number of objects related to it, such objects including but not limited to attributes, options, variations, categories and the like. Each such object can have its own unique identifier within a store.

With such a configuration, it is possible to create a store by making a copy of an existing store. If all of the identifiers are changed correctly, future changes to either store does not affect the other store. Given a relationship between a parent store and a child store, changes can be propagated between the parent and child stores by using push and pull operations. In particular, elements in parent store can be selected and applied to selected child stores by an administrator at the parent store level (a “parent administrator”). Similarly, elements from a parent store can be selected and applied to a particular child store by an administrator at the child store level (a “child administrator”). Because different entities may have different access rights to make such modifications, both implementations can be provided to assist different users in developing a store. In some implementations, it is possible to additionally determine whether a given object is exposed as a copyable object for to any child stores at all, for example by having an attribute of the object indicate whether the object is exposed to being pulled to a child store.

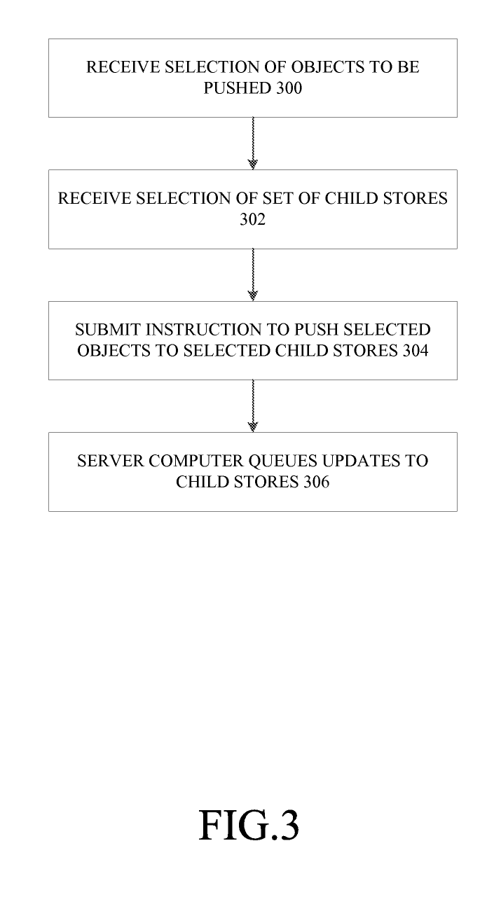

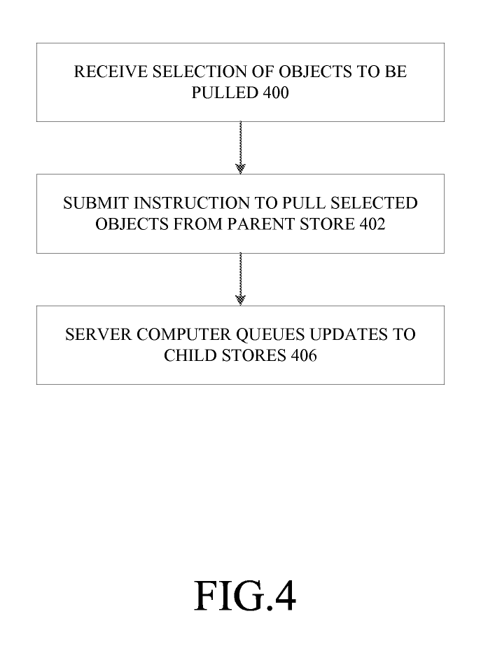

Referring now to FIGS. 3 and 4, a flow chart for example implementations of push and pull operations will now be described.

In FIG. 3, a push operation is described. A graphical user interface is presented to a user, such as an administrator of a parent store on an administrator client computer, from which a user can select objects to be pushed. The administrator client computer receives 300 the indications of the objects that have been selected. The graphical user interface can be provided by a browser application on the administrator client computer that communicates with the server system. The server system queries available objects for a parent store, and combines information about those objects in data sent to the administrator client computer, which displays information in the browser application. Similarly, the server system queries the database to identify available child stores for the parent store. This information is combined into interactive graphical user interface information that is sent to the administrator client computer. The graphical user interface is presented to the user on the administrator client computer, and the user selects child stores to which the selected objects are to be pushed. The administrator client computer receives 302 the indications of the child stores that have been selected. An instruction from the user is then received by the administrator client computer, indicating that the selected objects are to be pushed to the selected stores, which instruction is submitted 304 to the server system. The server computer then queues update instructions to the database to update the child store 306.

In FIG. 4, a pull operation is described. The pull operation is performed by an administrator related to a child store, in the context of development of the child store. A graphical user interface is presented to a user, such as on the administrator client computer, from which a user can select objects to be pushed. The administrator client computer receives 400 the indications of the objects that have been selected. The graphical user interface can be provided by a browser application on the administrator client computer that communicates with the server system. The server system queries objects for a parent store that are available for the currently active child store, and combines information about those objects in data sent to the administrator client computer, which displays information in the browser application. An instruction from the user is then received by the administrator client computer, indicating that the selected objects are to be pulled from the parent store to the currently active child store, which instruction is submitted 402 to the server system. The server computer then queues update instructions to the database to update the child store 404.

Because a large number of objects may be copied in response to a push or pull operation, the copying operation of each object can be placed in a task queue and performed asynchronously by the system. Because a copy operation can create conflicts as described below, a copy task can have a state, such as completed, in process, queued, or collision detected. If a collision is detected, a graphical user interface that displays the queue can be configured to allow an administrator to select a task with a collision and provide inputs for resolving the collision.

When updating a child store, given selected objects to be propagated to the child store, there are a variety of consequences that could arise which are addressed by the server system while doing the updates. In particular, conflicts between the information in the parent store and the child store can arise.

For an example of a conflict, if a product is pulled from parent or pushed to a child, it may have variations, options and other attributes that also are propagated to the child store. In some implementations, such other objects also may have their own identifiers. If the identifiers are unique, then they can be added to the child store without conflicts arising. However, if the identifiers of the objects in the parent store conflict with identifiers used in the child store, then these conflicts can be addressed, for example, by creating new objects in the child store with new identifiers corresponding to the pushed parent objects. Alternatively, the child store objects can be overwritten. Alternatively, the parent store objects may not be copied. A user interface can be presented to an administrator to advise whether a conflict has been detected, and requesting instruction for a resolution of the conflict, i.e., describing how the two information sets should be merged.

As another example of a conflict, a store has a catalog with a tree of categories. Each item can be associated with one or more categories. When an item is propagated by a push or pull operation to a child store, the categories to which the item belongs (and the portion of the tree of categories in which these categories reside) in the parent store can be copied over into the child store catalog and added to the tree of categories in the child store. If copying an item automatically copies its associated categories, then copying an item can lead to collisions between existing child-store categories, which may have been modified, and “canonical” parent-store categories.

For example, the item's categories may already be in the child store catalog. If the categories to be copied identically match the categories in the child store catalog, then no copying is performed. If the categories with the same identifiers are associated with different display names, then no copying is performed and the child store can keep its own display names for the category. Other types of collisions can cause a user interface prompt to the administrator, requesting instructions regarding how to resolve each kind of collision. Such collisions can include, but are not limited to, a. categories with identical identifiers and display names but different parent identifiers, b. categories with identical identifiers but different display names and parent identifiers, c. categories with identical display names but different identifiers or different parent identifiers, and the like. An administrator can then provide an input indicating how the category information of the two stores should be merged, such as whether the category of the parent store should not be copied, or whether the category of the child store should be overwritten, or whether a new category should be created in the child store, or the like.

As another example of a conflict, if a product is defined as incorporating another object, such as a scrapbook that incorporates a page template, and may include multiple pages of that template. When the product is pushed to a client store, the incorporated objects, such as a template, can be copied, creating a new object with a new identifier. In this instance the object can be modified by the child store without affecting other stores. In another implementation, the incorporated objects can be referenced by the new objects in the client store. However, such objects are implemented in a way that only allows an administrator of the parent store to change it. For example, each object can have an owner such that only the owner can change the object. For such an object, an administrator of the child store can save any modifications as a new object.

This problem can be exacerbated where a store deals with copies of products that are linked to graphical content, such as photobooks. Consider a store product S which represents a personalizable graphical object, such as a calendar. The product S has a price, dimensions and description, etc., and is associated with one or more categories. A customer can personalize the calendar, for example by dragging photos into frames or entering birthday dates or by performing other actions to provide or modify content. Product S also is associated with a graphical template G which defines things like fonts, frame sizes, clip art, etc., which holds the content.

A graphical template G is edited by administrators differently than it is experienced by end users. Administrators can modify the template, for example to fix a typographical error in some text, or add a team logo, etc. End users are typically subject to constraints, such as being prevented from removing the logo or changing the team name.

When an end user orders a product based on a template, the system creates a new Work In Progress item (WIP) which is a copy of the original graphic template G, taken at the moment the user began ordering the product (so that subsequent edits to product S will not affect WIP1, WIP2, . . . ). In one implementation, the link from product S to template G takes the form of a serial number which dereferences to the root of a graphical file in a database. That file can be a single file like a photoshop PSD file or the root node of a complex tree of entries in a content management system (CMS) database, or otherwise stored in a manner such that it can be found using the identifier.

When the product S exists in a hierarchy of stores, and is offered in a parent store, when a child store offers the product S, the product S copied and given a new identifier in the child store. For example, the parent's instance of the product S can be given the name “PS” and the copied version in the child store can be given the name “CS”. If both products reference the same template G, then when the parent store administrator opens the template G (e.g., to update the master template) they may find that the child store administrator has edited the template G for their own purposes. And if 100 stores have taken copies of product S, then there may be many people “fighting” over the single file template G and overwriting one another's work. Asking the administrators of the different child stores to copy the template, rename it and relink it to the copied products is too error-prone.

To address this problem, in one implementation, when a product being copied contains a reference to a template, the system determines that product PS references template G, creates product CS, copies template G to template G′, and then associates product CS to template G′.

In another implementation, template G can be a “Template” that when opened for editing creates an untitled document in the editing application which prevents the user from saving the template without giving it a new name, for example by setting file access permissions.

In another implementation, the identifier such as a serial number for the template G can be configured such that the authoring tool knows that it cannot be overwritten. This identifier for template G can be transformed, for example by encryption, into a new public-facing number G′. The parent administrator of the template G can know the identifier for the template G and can open/edit/resave the template G at will. However the identifier associated with the product S is the transformed or encrypted G′. The CMS system is configured to track that G′ references G for editing by customers. Particularly, when a customer edits product S, a WIP is created by copying the template G, but the child administrator does not have a way to get to the template G from the transformed identifier G′ and so cannot modify the original template G.

For another way to manage conflicts, the relationship between the child store object and parent store objects can be tracked, with the child store object including a reference to the parent store object from which it was derived. A graphical user interface can be created, in response to a query to the store databases, to illustrate to an administrator, for any given object in the child store, whether the parent object has changed. If such a change is indicated, the graphical user interface can be configured to enable a user to input a command to instruct the system to update the child store object based on the changed parent store object.

Having now described an example implementation, a general purpose computer in which components of such a system can be implemented will now be described. The following description is intended to provide a brief, general description of a suitable computer with which components of this system can be implemented. The system can be implemented with numerous general purpose or special purpose computing hardware configurations. Examples of well known computers that may be suitable for any given component include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

FIG. 5 illustrates an example computer 500. A computer 500 typically includes at least one processing unit 502 and memory 504. The computer may include multiple processing units and/or additional co-processing units such as graphics processing unit 520. Memory 504 may be volatile (such as RAM), non-volatile (such as ROM, flash memory, etc.) or some combination of the two. This configuration is illustrated in FIG. 5 by dashed line 506.

Computer 500 may include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer program instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other storage device which is recorded or read optically, magnetic cassettes, magnetic tape, magnetic disk storage or other magnetic storage devices, or any other storage medium which can be used to store the desired information in addressable physical storage locations that can be accessed by computer 500. Any such computer storage media may be part of computer 500. A storage medium is a medium in which data can be stored in and retrieved from addressable physical storage locations by the computer.

Computer 500 may also contain communications connection(s) 512, which are interface devices that allow a computer to connect to and communicate with other devices over a communication medium. By way of example, and not limitation, communication media includes wired media such as a wired network or direct-wired connection, and wireless media such as acoustic, RF, infrared and other wireless media.

Computer 500 may have various input device(s) 514 such as a keyboard, mouse, pen, camera, touch input device, and so on. Output device(s) 516 such as a display, speakers, a printer, and so on may also be included. All of these devices are well known in the art and need not be discussed at length here.

The various components in FIG. 5 are generally interconnected by an interconnection mechanism, such as one or more buses 530.

Components of such a system may be implemented using specially designed hardware components using software on a general purpose programmable computer, including computer-executable instructions and/or computer-interpreted instructions, such as program modules, being processed by the computer. Generally, program modules include routines, programs, objects, components, data structures, and so on, that, when processed by a processing unit, configure the computer to perform particular tasks or implement particular abstract data types or implement particular components. This system may be practiced in distributed computing environments where tasks are performed by remote processing devices that are linked through a communications network. In a distributed computing environment, program modules may be located in both local and remote computer storage media including memory storage devices.

It should be understood that the subject matter defined in the appended claims is not necessarily limited to the specific implementations described above. The specific implementations described above are disclosed as examples only.

What is claimed is:

1. A computer system for managing online stores comprising:
a store database including computer storage and data stored in the computer storage comprising data representing a plurality of stores, the data including objects representing at least items and objects associated with the items;
a server computer configured to access the data representing the plurality of stores, and being responsive to instructions from a user to push selected objects from a store to one or more other stores or to pull selected objects from a store to another store.

2. The computer system of claim 1, wherein the objects associated with items include options that when selected by a customer do not change price of an item.

3. The computer system of claim 1, wherein the objects associated with items include variations that when selected by a customer change price of an item.

4. The computer system of claim 1, wherein the server computer is further configured to:
cause a graphical user interface to be presented to a user indicating objects of a store for selection;
cause a graphical user interface to be presented to a user indicating child stores available for selection;
receiving an indication of objects and child stores selected through the graphical user interface; and
causing the selected objects to be pushed to the child stores.

5. The computer system of claim 1, wherein the server computer is further configured to:
cause a graphical user interface to be presented to a user associated with a child store and indicating objects of a parent store for selection;
receiving an indication of objects selected through the graphical user interface; and
causing the selected objects to be pulled to the child store.

6. The computer system of claim 1, wherein at least one of the selected objects includes one or more other objects, and the server computer is configured to determine if the one or more other included objects has an identifier conflicting with an identifier of another object in the child store.

7. The computer system of claim 6, wherein the selected object is a product, and the included object is a template used to create the product.

8. The computer system of claim 6, wherein the selected object is a product, and the included object is an option for the product.

9. The computer system of claim 6, wherein the selected object is a product, and the included object is a variation of the product.

10. The computer system of claim 6, wherein the selected object is a product, and the included object is an attribute of the product.

11. The computer system of claim 6, wherein the selected object is a product, and the included object is a category for the product.

12. The computer system of claim 1, wherein at least one of the selected objects is a product and the product includes a template, and the server computer is configured to prevent a child store administrator from modifying the template used by the product in a parent store.

13. The computer system of claim 1, wherein each object in a parent store has an attribute indicating whether the object is exposed to child store administrators to permit pulling the object to a child store.

14. The computer system of claim 1, wherein the server computer is configured to queue requests to propagate information about the selected objects from a parent store to a child store.

15. The computer system of claim 1, wherein at least one of the selected objects is a product, and the object related to the product is a category in a tree of categories, and the server computer is configured to copy a portion of the tree of categories incorporating the category for the product.

16. The computer system of claim 15, wherein the server computer is further configures to prevent conflicts between categories in the child store and categories in the parent store.

17. The computer system of claim 1, wherein the items include products associated with templates for arranging graphical images.
